(19) United States
(12) Patent Application Publication
(10) Pub. No.: US 2026/0161018 A1
(43) Pub. Date: Jun. 11, 2026

(54) REVERSIBLE EYEWEAR

(71) Applicants: Isaac Maresky, Toronto (CA); Gregory Laredo, Thornhill (CA)

(72) Inventors: Isaac Maresky, Toronto (CA); Gregory Laredo, Thornhill (CA)

(21) Appl. No.: 19/358,362

(22) Filed: Oct. 14, 2025

Related U.S. Application Data
(63) Continuation-in-part of application No. 18/967,546, filed on Dec. 3, 2024.

(51) Int. Cl. G02C 5/22

(52) U.S. Cl. CPC G02C 5/22

(57) ABSTRACT

Reversible eyewear that is non-magnetic. Pivoting two temple pieces relative to two eye rim lens frames between two reversible orientations causes the temple pieces to pass through respective orientations in which the temple pieces extend outward colinear with adjacent ones of the two eye rim lens frames. If both of the two temple pieces are pivoted into the respective orientations simultaneously, the two temple pieces extend in opposite directions relative to each other to form an angle of 180 degrees. If rotated one at a time, after one reaches its reverse orientation, the two temple pieces extend parallel to each other and in opposite directions from the hinge units to which they connect respectively.

### CROSS-REFERENCE TO RELATED APPLICATIONS

This is a continuation-in-part of U.S. patent application Ser. No. 18/967,546 filed Dec. 3, 2024, whose contents are incorporated herein by its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE

Not applicable.

### STATEMENT REGARDING PRIOR DISCLOSURES BY THE INVENTOR

Through Peeq Corp., what was offered for sale over one year ago was reversible eyewear that was equipped with magnets in its lens frame that were in close proximity to magnetically attractive elements in the vicinity of hinges between the lens frame and temple pieces.

### BACKGROUND OF THE INVENTION

### Field of the Invention

The invention relates to reversible eyewear worn about the head and a method of reversing an orientation of the temple arms relative to the lens frame with hinge units.

### Discussion of Related Art

U.S. Pat. No. 9,726,900 B1, which is incorporated herein by reference in its entirety, discloses a magnetically locking reversible eyewear and method of reversing orientation of same. Peeq Corp. (hereinafter “Peeq”) acquired ownership of U.S. Pat. No. 9,726,900 B1. Over the years, Peeq has iterated several generations of prototypes, testing different options of technologies and materials. Peeq designed 5 different models of reversible sunglasses for the very first launch batch and are available for purchase on the website peeqglasses.com.

The Peeq sunglasses have a locking mechanism that has a dual-rotating hinge that enables the horizontal reversing of the temple pieces and that allows the color of the temple pieces across the entire length to be reversible including the entire endpiece of the lens frame and the temple pieces may bend down around the wearer's ear for better fit and for preventing the Peeq sunglasses from sliding off face. That is, when one reverses the temple pieces vertically, they need to be completely flat because any bend down around the ear would conversely bend up above the ear when reversed.

It would be desirable to provide for non-magnetic, reversible eyewear whose outside facing color of its temple pieces is reversible with the rotation of the temple pieces via a dual-rotating hinge and configured to provide flexibility for fit around the ear to prevent sliding off the face. Preferably, a locking mechanism provides sufficient force to keep the dual-rotating hinge in position until it is rotated under manual force to carry out the reversibility action for the temple pieces.

### BRIEF SUMMARY OF THE INVENTION

One aspect of the invention resides in reversible eyewear that has a lens frame, a pair of temple arms and a pair of hinge units. The hinge units connect the pair of temple arms to opposite ends of the lens frame, which is elongated between the opposite ends. Each hinge unit has a respective locking piece that is rotatable between two relative positions. Preferably there are no magnets. The outside facing color of its temple pieces is reversible with the rotation of the temple pieces via a dual-rotating hinge and configured to provide flexibility for fit around the ear to prevent sliding off the face.

### BRIEF DESCRIPTION OF SEVERAL VIEWS OF THE DRAWING

For a better understanding of the present invention, reference is made to the following description and accompanying drawings, while the

FIG. 1 is an isometric view of reversible eyewear with its locking units in locked positions and its temple pieces extending rearward from the lens frame in a non-reversed position in accordance with U.S. Pat. No. 9,726,900.

FIG. 2 is an isometric view of the reversible eyewear as in FIG. 1, but with one of its locking units rotated into an unlocked position from the locked position of FIG. 1.

FIG. 3 is an isometric view of the reversible eyewear as in FIG. 2 with one of its locking pieces in the unlocked position, but with its temple piece extending out to the side horizontally after having been pivoted from its rearward orientation in FIG. 2.

FIG. 4 is an isometric view of the reversible eyewear with the one of its locking pieces in a locked position after being rotated from the unlocked position of FIG. 3 and with its associated temple piece in a reversed position from that of FIG. 1 after being further pivoted from its orientation in FIG. 3.

FIG. 5 is an exploded view of the reversible eyewear of FIGS. 1-4.

FIG. 6 is an exploded view of the reversible eyewear in accordance with the present invention.

### DETAILED DESCRIPTION OF THE INVENTION

The contents of U.S. Pat. No. 9,726,900 B1 are incorporated by reference in its entirety.

Peeq Corp. commercializes reversible sunglass eyewear based on U.S. Pat. No. 9,726,900 B1. The present inventors experimented with that Peeq Corp. reversible eyewear by removing its magnets from the frame and found that the temple pieces are restrained against relative movement sufficiently that they do not self-close. Instead, manual force is needed to move them between their open and closed positions.

The present inventors have found that the reversible feature functions satisfactorily even if all the magnets are removed and holes for them are filled in.

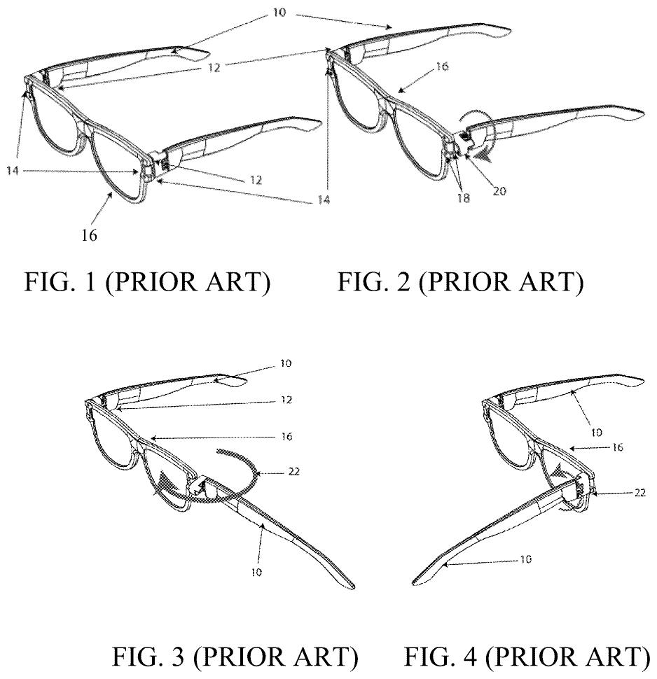

Turning to the drawing, FIGS. 1-4 show progressive views of reversible eyewear in accordance with the invention that correspond to FIGS. 1-4 of U.S. Pat. No. 9,726,900 B. The present invention differs in that there are no magnetically attractive elements 18 and no recesses for accommodating magnetically attractive elements 18 because the recesses are filled in with the same material as that of the structure adjacent to the recesses. The eyewear includes two temple pieces 10, two hinge units 12, two opposite ends 14 of a lens frame 16. Each hinge unit 12 has a rotatable locking unit 20. The locking unit 20 of FIG. 1 may be rotated clockwise from its relative position to reach the relative position of FIG. 2.

FIG. 1 shows an assembly with the temple pieces 10 in their initial orientation extending rearward from the lens frame 16, In order to reverse the orientation of the temple arms relative to the lens frame, the following manual operation is performed. First, the rotatable locking piece 20 is rotated from its locked position of FIG. 1 to an unlocked position of FIG. 2. Next, the unlocked one of the temple pieces 10 is pivoted in a horizontal plane to the orientation of FIG. 3 and continued in the direction of the direction arrow until reaching the reversed position of FIG. 4 and the unlocked locking unit 20 is rotated into its locked position. With respect to FIG. 4, the two temple pieces 10 extend in opposite directions away from their respective hinge unit 12 and parallel to each other.

In accordance with the present invention, the two hinge units lack any magnetically attractive elements that are magnetically attracting each other and are configured to pivot between two reversible orientations so that for one of the two reversible orientations, the two temple pieces 10 extend outward in a common direction from respective ones of the two hinge units 12 (see FIG. 1) and for a remaining one of the two reversible orientations, the two temple pieces 10 extend outward in an opposite direction, that is, opposite that of the common direction (shown for one of the two temple pieces 10 in FIG. 4).

The assembly is configured so that the two temple pieces 10 are manipulated into an orientation of FIG. 4 in which both temple pieces 10 extend parallel to each other while extending in opposite directions from each other from respective ones of the two hinge units and also into another orientation of FIG. 3 in which both temple pieces extend in opposite directions from each other with an angle of inclination between of 180 degrees.

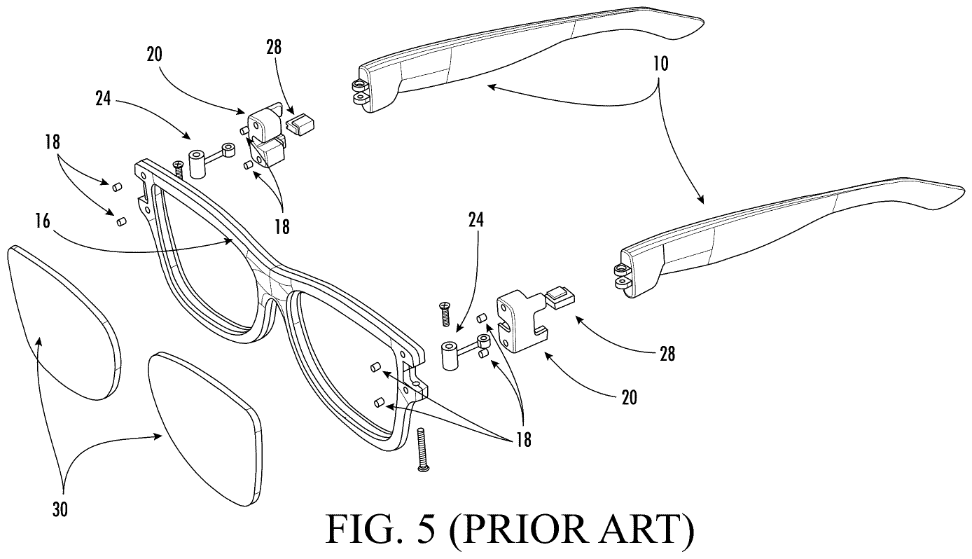

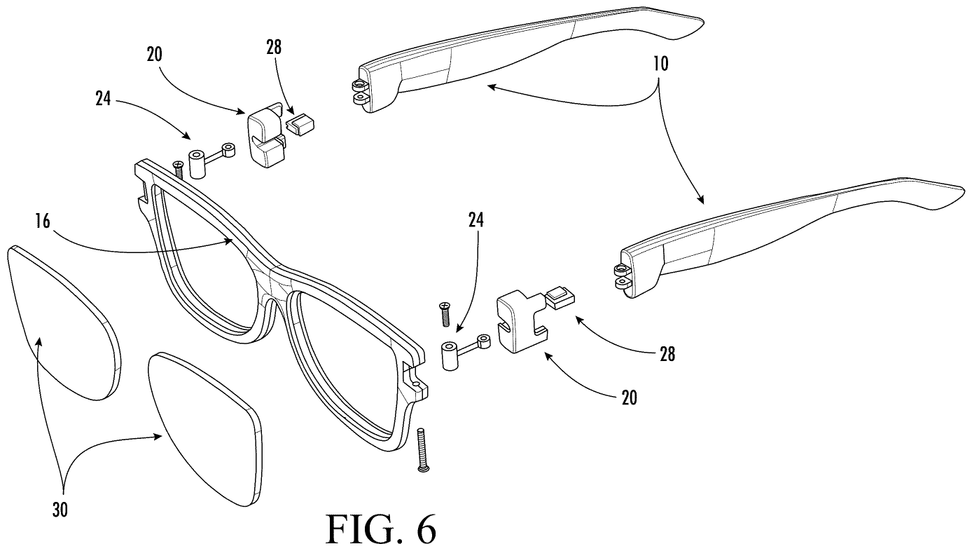

Turning to FIGS. 5 and 6, which are similar except that FIG. 5 corresponds to FIG. 5 of U.S. Pat. No. 9,726,900 B1 and FIG. 6 corresponds to the present invention, which differs from FIG. 5 in that there are no magnetically attractive elements 18 and no recesses for accommodating the magnetically attractive elements 18. Such is shown in FIG. 6. There is a lens frame 16 into which is fitted lenses 30 in a conventional manner. The temple pieces 10 connect to ends of the lens frame via hinge units. Each hinge unit includes a hinge piece 24, the locking unit 20 and a link piece 28. The hinge piece 24 is connected to the end of the lens frame in a conventional manner with conventional fasteners and is connected to the link piece 28 such that the locking piece 20 is freely rotatable on the hinge piece 24. The link piece 28 is connected to the temple arm 10 in a conventional manner.

When pivoting the two temple pieces 10 relative to the two eye rim lens frames 16 between the two reversible orientations, the temple pieces 10 pass through respective orientations in which the temple pieces extend outward colinear with adjacent ones of the two eye rim lens frames. One of the respective orientations is shown in FIG. 3. The other respective orientations can be envisioned by the other of the two temple pieces 10 being pivoted than is shown pivoted in FIG. 3 to reach a position colinear with the other of the two eye rim lens frames 16. Thus, if both of the two temple pieces are pivoted into the respective orientations simultaneously, the two temple pieces 10 would extend in opposite directions relative to each other separated from each other by the eye rim lens frames 16.

While the foregoing description and drawings represent the preferred embodiments of the present invention, various changes and modifications may be made without departing from the scope of the present invention.

What is claimed is:

1. A reversible orientation eyewear, comprising:
an eyewear assembly that includes two temple pieces, two lenses, a nose bridge unit that separates the two lenses from each other, and two reversible hinge units connecting the two temple pieces and arranged neighboring respective ones of the two lenses, the nose bridge unit being arranged equidistant from the two reversible hinge units;
wherein the two reversible hinge units lack any magnetically attractive elements that are magnetically attracting each other and are configured to pivot between two reversible orientations so that for one of the two reversible orientations, the two temple pieces extend outward in a common direction from respective ones of the two hinge units and for a remaining one of the two reversible orientations, the two temple pieces extend outward is an opposite direction that is opposite that of the common direction,
wherein the assembly is configured so that the two temple pieces are manipulated into an orientation in which both temple pieces extend parallel to each other while extending in opposite directions from each other from respective ones of the two hinge units and also into another orientation in which both temple pieces extend in opposite directions from each other with an angle of inclination between of 180 degrees.

2. The reversible orientation eyewear of claim 1, wherein the assembly includes two lens frames that retain lenses, the two lens frames being connected to the nose bridge unit and to respective ones of the two hinge units.
